(19) United States
(12) Patent Application Publication
(10) Pub. No.: US 2026/0319138 A1
(43) Pub. Date: Oct. 15, 2026

(54) HIGHLY TRANSPARENT WINDOW INSERT

(71) Applicant: Nxlite Technologies Inc., Canton Township, MI (US)

(72) Inventors: Jose NUNEZ-REGUEIRO, Ann Arbor, MI (US); Paulo Cesar DE MOURA, Canton, MI (US); Nazir Pyarali KHERANI, Toronto (CA); Alexey KRASNOV, Canton, MI (US)

(21) Appl. No.: 19/410,444

(22) Filed: Dec. 5, 2025

Related U.S. Application Data
(60) Provisional application No. 63/728,813, filed on Dec. 6, 2024.

(51) Int. Cl. G02B 1/116; E06B 3/28; G02B 1/14; G02B 5/20; G02B 5/26

(52) U.S. Cl. CPC G02B 1/116; G02B 5/208; G02B 5/26; E06B 3/28; G02B 1/14

(57) ABSTRACT

The present disclosure provides highly transparent window inserts which are solar control structures that use a combination of high-index-of-refraction (high-IOR), with IOR≥2.3 at 550 nm, and medium index-of-refraction (medium-IOR) with 1.8≤IOR<2.2 dielectrics in the subjacent region (between the substrate and the infrared reflecting functional layer). This configuration allows for a simplified stack with fewer layers while providing enhanced visible transmission and greater control over color properties. The presented stack is ideally suited for polymeric or thin alkali-free, such as Corning aluminosilicate or fusion, glass substrates.

### FIELD

The present invention relates to infrared reflective solar-control structures and, particularly, to solar-control structures comprising at least one silver-based coating having improved visible light transmission. Yet more specifically, the invention relates to solar-control structures comprising plastic substrates.

### BACKGROUND

Silver based infrared (IR) reflective solar-control structures are known in art and are widely employed in various applications such as energy-efficient architectural and automotive glazing. One of the significant advantages of a silver based solar-control coating is the fact that silver allows the sharpest transition of its optical transmission curve between the visible and near-IR spectral ranges. In other words, it enables the coating to be highly transparent in the visible while substantially blocking the near-IR light, thus providing thermal comfort to the building or vehicle occupants.

Of particular interest are lightweight solar-control structures based on polymer substrates, such as polymethyl methacrylate (PMMA), polycarbonate (PC), etc. One of the most important attributes of such structures, beyond their lighter weight and relatively unbreakable character, is their high transmittance compared to visible light transmittance (Tvis) of glass. The higher the Tvis the more daylight can pass through the glazing. High Tvis values are especially important in the case of retrofit window inserts since each added pane, although enhancing thermal insulation, also tends to reduce total visible transmittance.

Manufacturers of coated glazing have developed proprietary optical designs of silver-based coatings to increase Tvis and reduce infrared (IR) reflectance at the same time. Most solar-control coatings are deposited on glass and use at least one thin functional layer of silver separated from the substrate by a subjacent portion comprising one or several dielectric layers having an index of refraction (IOR) of at least 1.95 at 550 nm as well as optional supplemental dielectrics. The typical choice of the separation layers includes silicon nitride (SiNₓ, IOR=2.05); zinc oxide (usually Al-doped, ZnAlOₓ, IOR=2.0), zinc tin oxide (ZnSₙOₓ, IOR=2.0); and titanium oxide (TiOₓ; IOR varies between 2.25 for amorphous to 2.7 for rutile phase). In the above formulae, ‘x’ denotes the fact that the material composition may slightly deviate from that of a purely stoichiometric compound. TiOₓ belongs to high-IOR dielectrics while the rest of the above-mentioned dielectrics with IOR below 2.2 are considered medium-IOR materials. SiNₓ is typically deposited at the coating/glass interface due to its superior barrier properties against the diffusion of sodium and other alkaline elements from the glass substrate. This quality is primarily important at high processing temperatures of glass manufacturing processes, such as tempering, heat activation, or thermal bending. TiOₓ, ZnAlOₓ, or ZnSₙOₓ, or a combination thereof is typically used as a complementary dielectric or a set of dielectrics. ZnAlOₓ is often used as a so-called wetting layer to improve the crystallinity of silver which is deposited directly on it.

Quite recently, aluminum nitride (AlN) was shown to demonstrate excellent performance characteristics when used as a dielectric in solar-control stacks (CA3061105A, http://dx.doi.org/10.1016/j.surfcoat.2015.12.015).

TiOx , despite adding more freedom to the optical design of the coating due to its high IOR, also adds some complexity. Sputtered TiOₓ is known to grow amorphous at room temperature but typically crystallizes to predominantly rutile or anatase form after post-deposition heat activation or glass tempering. Stoichiometric as-deposited TiO₂, for example, has a higher probability to transition into anatase form while sub-stochiometric—in rutile—and may additionally transition from one phase to another depending on the post-deposition processing conditions. Despite being more stable and having a higher IOR compared to anatase, rutile TiOₓ (IOR is about 2.7) has the significant disadvantage of adding unwanted optical absorption and coloration to the coating.

Another sputtered high-IOR dielectric candidate, niobium oxide (NbOₓ), especially niobium pentoxide (Nb₂O₅), is more stable compared to TiOₓ, so it is less prone to phase transition and degradation. It also exhibits better chemical stability under various conditions [https://doi.org/10.1016/j.tsf.2015.02.047]. The IOR of amorphous Nb₂O₅ is 2.4 at 550 nm, which is higher than 2.25 of amorphous TiO₂. Nb₂O₅ is also known to be superior to TiO₂ dielectric as far as its transparency in the visible is concerned due to its wider bandgap of 3.4 eV compared to 3.2 eV for TiO₂.

On the flip side, NbOₓ sputtering targets are more expensive compared to their TiOₓ counterparts. Primarily for the latter reason, TiOₓ is used in the glass coating industry virtually ubiquitously, despite the fact that a lower IOR of TiOₓ as compared to that for NbOₓ generally results in inferior antireflection properties of the solar-control stack. Said deficiency must be compensated by adding more layers to the optical design comprising TiOₓ as a high-IOR dielectric. This adds to the product cost due to materials consideration, reduced deposition line speed or/and additional deposition zones, compromised yield, etc.

The use of NbOₓ in solar-control stacks is known in art. U.S. Pat. No. 7,455,910B2 discloses NbOₓ below the functional silver layer but also applies a nickel-chromium-oxide (NiCrOₓ) or nickel-chromium nitride (NiCrNₓ) layer between NbOₓ and Ag.

CN207808650U discloses NbOₓ but requires the deposition of a diamond-like-carbon or a thin metal layer between NbOₓ and silver.

CA2170192C discloses the use of NbOₓ under the silver but also requires the use of a layer with low IOR (≤1.7).

CN212269961U also discloses a NbOₓ layer but is limited to polyester as substrate material and the material choice of the first two layers from the list of indium-tin-oxide, silicon dioxide, and silicon nitride.

CN206623483U discloses the use of NbOₓ but does not disclose an AlN layer

NbOₓ is usually amorphous when sputtered at room temperature. During post-deposition heat treatment, it may transition to one or more crystalline polymorphs, such as hexagonal, orthorhombic, and monoclinical (hexagonal phase is dominant following typical heat activation or tempering of coating-on-glass at temperatures of 600-700 °C). Unlike glass substrates, however, plastic panes are generally not intentionally heated-neither during the deposition, nor after it. The reason is that excessive heat would destroy the substrate material before providing any noticeable activation benefits to the solar-control coating. Without post-deposition heat treatment NbOₓ stays predominantly amorphous with its superior index of refraction and optical transparency compared to amorphous TiOₓ.

It would be desirable to provide a solar-control coating on a plastic substrate having a simple yet optically efficient design as well as delivering mechanically and chemically durable performance based on NbOₓ which is deposited and processed without intentional heating.

### SUMMARY OF THE CLAIMS

Disclosed herein is a solar-control structure comprising an optically transparent alkali free substrate (100) with a first dielectric layer (110) located on a surface of the substrate (100) and having an index of refraction of at least 2.3 at a wavelength of about 550 nm and comprising a substantially amorphous oxide of Nb or one of its alloys with Zr or Hf or a substantially amorphous oxide or nitride of Zr, wherein the thickness of said first dielectric layer (110) layer is from about 10 nm to about 20 nm. A second dielectric layer (120) is located on the first dielectric layer (110) having an index of refraction smaller than about 2.2 but not smaller than about 1.8, wherein a thickness of said second dielectric layer (120) ranges from 0 nm to about 50 nm. A wetting layer (125) is located on second dielectric layer (120) and has a thickness from 0 to about 20 nm. A first infrared reflecting functional layer (130) is located on wetting layer (125) and has a thickness that ranges from 0 to about 15 nm, and is made of pure Ag. A second infrared reflecting functional layer (140) is located on first infrared reflecting functional layer (140) having a thickness in a range from 0 to about 15 nm. This second infrared reflecting functional layer is silver alloyed with Cu and Al. At least one of the first and second of the infrared reflecting functional layers is always present. A layer of NiCr or NiCrOₓ (0≤x≤0.6) (150) is located on top of the infrared reflecting functional layer (140) with a thickness ranging from 0 to about 4 nm. An AlN-based layer (160) is located on top of layer (150) with thickness ranging from about 5 nm to about 50 nm. A layer (170) of SiOₓN_{y} (0≤x≤1; 1≥y≥0) is located on top of layer (160) with thickness ranging from about 10 nm to about 30 nm. There is no dielectric layer above the first and/or second infrared reflecting functional layers with an index of refraction equal to, or greater than about 2.1 at 550 nm.

The oxide of Nb or one of its alloys with Zr or Hf of the first dielectric layer (110) may include Nb₂O₅, (Nb, Zr)O₂, and (Nb, Hf)O₂.

The nitride of Nb with Zr or Hf of the first dielectric layer (110) may include NbZrN and NbHfN.

The AlN-based layer (160) may be AlN.

The e AlN-based layer (160) may have any one of AlN:H, AlNₓO_{y}.

Only the first infrared reflecting functional layer (130) may be present.

Only the second infrared reflecting functional layer (140) may present.

Both the first and second infrared reflecting functional layers (130) and (140) may be present.

The second dielectric layer (120) may have a thickness of 0 nm so that it is absent.

The second dielectric layer (120) may have a thickness of greater than 0 nm so that it is present.

The layer (150) of NiCr or NiCrOₓ may have a thickness of greater than 0 nm so that it is present.

The solar layer (150) of NiCr or NiCrOₓ may have a thickness of 0 nm so that it is absent.

The wetting layer (120) may have a thickness of 0 nm so that it is absent.

The wetting layer (120) may have a thickness of greater than 0 nm so that it is present.

The second dielectric layer (120) may be AlN.

The solar-control structure may further comprise a third dielectric layer (322) located on top of dielectric layer (320) having an index of refraction of at least 2.3 at a wavelength of about 550 nm and comprising an oxide of Nb or one of its alloys with Zr or Hf or an oxide or nitride of Zr, wherein the thickness of this layer is from about 10 nm to about 20 nm, and may further comprise a fourth dielectric layer (324) on top of second dielectric layer (322) and below the infrared reflecting functional layer (330) and having an index of refraction in a range from about 1.8 to about 2.2.

The optically transparent alkali free substrate (100) may have a thickness from about 0.5 mm to about 16 mm.

The optically transparent alkali free substrate may be a transparent polymeric plastic or alkali free glass.

The present disclosure also provides a solar-control structure comprising a an optically transparent alkali free substrate (200) having a first dielectric layer (210) located on a surface of the substrate (200) and having an index of refraction of at least 2.3 at a wavelength of about 550 nm and comprising a substantially amorphous oxide of Nb or one of its alloys with Zr or Hf or a substantially amorphous oxide or nitride of Zr, wherein the thickness of said first dielectric layer (210) layer is from about 10 nm to about 20 nm. A second dielectric layer (220) located on first dielectric layer (210) having an index of refraction smaller than about 2.2 but not smaller than about 1.8, wherein a thickness of said second dielectric layer (220) ranges from 0 nm to about 50 nm. A wetting layer (125) is located on second dielectric layer (220) having a thickness from 0 to about 20 nm. A first infrared reflecting functional layer (230) is located on wetting layer (125), wherein a thickness of the first infrared reflecting functional layer ranges from 0 to about 15 nm, the first infrared reflecting functional layer (230) being made of pure Ag. A second infrared reflecting functional layer (240) is located on first infrared reflecting functional layer (240) having a thickness in a range from 0 to about 15 nm, the second infrared reflecting functional layer being silver alloyed with Cu and Al, wherein at least one of the first and second of the infrared reflecting functional layers is always present. A layer of NiCr or NiCrOₓ (0≤x≤0.6) (250) is on top of the infrared reflecting functional layer (240) with a thickness ranging from 0 to about 4 nm. An AlN-based layer (260) is located on top of layer (250) with thickness ranging from about 5 nm to about 50 nm. A pure silver layer (262) is located on the AlN layer (260). A Ag—Cu—Al silver alloy layer (264) is located on layer (262) and a NiCr layer (266) is located on layer (264) with an AlN layer (268) located on layer (266). A layer (270) of SiOₓN_{y} (0≤x≤1; 1≥y≥0) on top of layer (268) with thickness ranging from about 10 nm to about 30 nm. There is no dielectric layer above the first and/or second infrared reflecting functional layers with an index of refraction equal to, or greater than about 2.1 at 550 nm.

The optically transparent alkali free substrate (200) may have a thickness from about 0.5 mm to about 16 mm.

The optically transparent alkali free substrate may be a transparent polymeric plastic or alkali free glass.

### BRIEF SUMMARY OF THE DETAILED DESCRIPTION

The present disclosure provides an improved optical design of an infrared (IR) reflective solar-control coating deposited on a plastic substrate to form, for example, an insert for improved thermal performance of existing windows. In its preferred design, the substrate and the coating are not intentionally heated during or after the deposition. By using a combination of niobium oxide (NbOₓ) with its high index of refraction (IOR) and robust medium-IOR aluminum nitride (AlN) (IOR=2.12 at 550 nm) layers in the subjacent (between the substrates and the silver layer) portion of the stack, the disclosed design enables very high levels of visible optical transmission (Tvis) as well as eliminates the need for silicon nitride (SiNₓ) and other complementary layers, such as zinc aluminum oxide (ZnAlOₓ), zinc tin oxide (ZnSₙOₓ), or titanium oxide (TiOₓ). High Tvis is crucial for high optical performance of window inserts while the simplicity of the stack results in fewer required interfaces and, thus, in a more robust structure. Besides its superior optical design due to the high IOR of NbOₓ, the disclosed combination enables excellent wetting conditions for the functional silver layer provided by AlN and adequate sodium blocking at room temperature provided by the NbOₓ and AlN combination. Note that wetting is the quality of a sublayer to provide favorable crystal orientation during the growth of the silver functional layer. Alternative to NbOₓ may be a layer comprising an oxide or nitride of zirconium. A combination of layers of NbOₓ and ZrOₓ or ZrN is also possible.

A combination of AlN and a high-IOR dielectric or dielectrics in the subjacent portion of a solar-control stack is disclosed in U.S. Pat. No. 9,708,215B2. Claim 1 of U.S. Pat. No. 9,708,215B2 particularly discloses: “ . . . a total optical thickness e2 of the high-refractive-index dielectric layer or of all of the high-refractive-index dielectric layers which is or are located in the subjacent antireflection film represents between 35 and 55% of the total optical thickness e20 of this subjacent antireflection film, and the total optical thickness e6 of the high-refractive-index dielectric layer or of all of the high-refractive-index dielectric layers which is or are located in the superjacent antireflection film represents between 10 and 60% of the total optical thickness e60 of this superjacent antireflection film . . . ”and“ . . . wherein the high refractive-index layer of the superjacent antireflective film is in direct contact with a first dielectric layer, which is not a high refractive-index layer . . . ”; U.S. Pat. No. 9,708,215B2 discloses high-index dielectrics as those having the IOR of no less than 2.2. Note that U.S. Pat. No. 9,708,215B2 primarily focuses on heat treatable stack options deposited on glass. Once again, in the case of plastic substrates, post-deposition thermal activation or tempering steps are not applied.

Compared to U.S. Pat. No. 9,708,215B2, the present invention allows significant simplification in the optical design of the stack and enables the use of the combined optical thickness of high-IOR dielectrics outside the optical thickness range in the subjacent portion disclosed in U.S. Pat. No. 9,708,215B2. In an example embodiment, the percentage of the optical thickness of NbOₓ, or ZrOₓ, or ZrN, or a combination thereof (high-IOR dielectrics) to the total optical thickness of dielectrics in the subjacent portion of the present invention is at least 57%, which is greater than the upper limit value of 55% disclosed in U.S. Pat. No. 9,708,215B2. The use of high-IOR NbOₓ or its alternatives in the present invention also allows eliminating the need of using a high-IOR dielectric in the superjacent (above the silver layer) portion of the stack. Fewer layers mean fewer interfaces between dissimilar materials. This is particularly important for coatings on plastic substrates since plastic is prone to greater thermal and load expansion and contraction compared to glass, which in turn is directly related to mechanical stresses placed on the coating.

FIG. 1A to FIG. 1D depict example solar-control coating designs according to the present invention.

In FIG. 1A, high-IOR NbOₓ or its alternatives and medium-IOR AlN dielectrics form the first anti-reflection portion of the stack. AlN also serves the role of a wetting layer for Ag to improve its crystallinity. The use of an alloyed Ag—Cu—Al layer on top of the pure silver layer, for example, ensures corrosion resistant properties of the combined Ag/Ag—Cu—Al functional layer. Use Ag—Cu—Al corrosion-resistant combinations has been disclosed by the inventors of the present invention in a separate patent application. Optional ultrathin NiCr is used as a blocker layer to further enhance corrosion resistant properties of silver as well as to protect it from damage due to bombardment by energetic sputtering species during the deposition. The stack is terminated with a second AlN (medium-IOR material) and SiOₓN_{y} (the composition may vary from SiO₂ to Si₃N₄), wherein SiOₓN_{y}, besides being an optically active material, also plays the role of a protective layer. Medium-IOR materials in the present invention are defined as those having an IOR in the range 1.8≤IOR≤2.2.

In FIG. 1B, an alternative design of the coating is presented, wherein only a corrosion resistant Ag—Cu—Al is used as an electrically conductive solar-control functional layer.

FIG. 1C shows another stack option with an additional wetting layer inserted between the bottom AlN and the silver functional layer. The purpose of this additional layer is to improve the crystallinity and, thus, IR-reflecting properties of the silver.

FIG. 1D shows another stack option with the medium-IOR layer in the subjacent portion and the blocker layer above the functional layer absent and only one of the two functional layers-either pure-Ag or Ag alloyed with Cu and Al present.

FIG. 2 shows another stack design using an additional bilayer silver functional layer. The use of additional silver functional layers further improves thermal insulation of the coated glazing.

FIG. 3 shows a solar-control stack comprising an additional pair of high-IOR and low-IOR dielectrics in its subjacent portion. The use of additional sequence of high-IOR and medium-IOR dielectrics further improves Tvis as well as increases the reflectance in the near-IR spectral range.

A remarkable attribute of the disclosed design of the present invention with a high-IOR NbOₓ in combination with medium-IOR AlN in the subjacent portion of the stack is a much wider locus of optical admittance (FIG. 4) as compared, for example, to that of the design disclosed in U.S. Pat. No. 9,708,215B2. The stack of the present invention is denoted in the figure as NX while the locus of the reference design of U.S. Pat. No. 9,708,215B2 is denoted as Ref.

FIG. 5 is a comparison of transmission (T), reflection from the film side (Rf), and reflection from the glass side (Rg) simulated from the preferred stack design of the present invention and U.S. Pat. No. 9,708,215B2.

FIG. 6 A comparison of transmitted and reflected (film side and glass side) color simulated from the preferred stack design of the present invention and U.S. Pat. No. 9,708,215B2.

### BRIEF DESCRIPTION OF THE DRAWINGS

The present invention can be understood by considering the following drawings and the legend for the reference numerals presented further below:

FIG. 1A is a schematic representation of the preferred embodiment of solar-control stack of the present invention using a combination of pure silver and alloyed Ag—Cu—Al functional layers.

FIG. 1B is a schematic representation of an alternative embodiment of solar-control stack of the present invention using only one alloyed Ag—Cu—Al functional layer.

FIG. 1C is a schematic representation of an alternative embodiment of solar-control stack of the present invention using an additional wetting layer between AlN and the silver layer.

FIG. 1D is a schematic representation of an alternative embodiment of solar-control stack of the present invention wherein the medium-IOR layer in the subjacent part of the stack, the blocker layer, and one of the functional layers either pure-Ag or Ag alloyed with Cu and Al-are absent.

FIG. 2 is a schematic representation of a solar-control stack using an additional bilayer silver functional layer.

FIG. 3 is a schematic representation of a solar-control stack using an additional pair of high-IOR and low-IOR dielectrics in its subjacent portion

FIG. 4 is a comparison of admittance loci of the preferred example embodiment of solar-control stack of the present invention depicted in FIG. 1A (denoted as NX) and that of a stack disclosed in U.S. Pat. No. 9,708,215 B2.

FIG. 5 is a comparison of transmission (T), reflection from the film side (Rf), and reflection from the glass side (Rg) simulated from the preferred stack design of the present invention and U.S. Pat. No. 9,708,215 B2.

FIG. 6 A comparison of transmitted and reflected (film side and glass side) color simulated from the preferred stack design of the present invention and U.S. Pat. No. 9,708,215 B2.

The accompanying drawings, which are incorporated in and form a part of this description, illustrate various embodiments of the invention, and together with the description, illustrate the principles of the invention, and enable those skilled in the art to make and use the invention.

### Definition of the Reference Numerals used in the Drawings

100, 200, 300 alkali free polymeric or thin glass or plastic pane
110, 210, 310 High-index dielectric
120, 220, 320 Bottom aluminum nitride
322 Second layer of bottom silicon nitride
324 Second layer of bottom aluminum nitride
125 Optional additional wetting layer
130, 230, 330 Pure silver
140, 240, 340 Alloyed silver layer
150, 250, 350 Nickel chrome
160, 260, 360 Top aluminum nitride
262 Second layer of pure silver
264 Second layer of alloyed silver
266 Second NiCr blocker layer
268 Second top AlN layer
170, 270, 370 Silicon-oxi-nitride (the composition may vary from silicon dioxide to silicon nitride)

### DETAILED DESCRIPTION

A detailed description is provided below to facilitate a thorough understanding of the disclosed embodiments and connections thereof. The description is not limited to any particular example included herein.

Various embodiments and aspects of the disclosure will be described with reference to the details discussed below. The following description and drawings are illustrative of the disclosure and are not to be construed as limiting the disclosure. Numerous specific details are described to provide a thorough understanding of various embodiments of the present disclosure. The Figures are not to scale. Further, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

The following terminology is used to describe the subject of the invention.

A glazing is an article comprising at least one layer of a transparent material which serves to provide for the transmission of light and/or to provide for viewing of the side opposite the viewer and which is mounted in an opening in a building, vehicle, wall or roof or other framing member or enclosure.

A solar-control coating is a thin-film coating providing partial reduction in the amount of solar radiative heat. The coating generally also exhibits low emissivity (low-E) properties, namely, providing high reflectivity in the mid-infrared range (ambient/room heat).

The substrate is an alkali free thin glass or alkali free polymeric plastic, from about 0.5 to about 16 mm thick. Polymeric substrate material examples include polycarbonate, PMMA, and polyethylene terephthalate. Glass material examples include aluminosilicate, borosilicate, and Corning fusion glass.

A functional layer is an infrared (IR) reflecting silver-based layer. Examples include a pure silver layer and a layer of silver alloyed with Cu and Al, or a bilayer—a combination thereof.

High-IOR materials in the present invention are defined as those having an IOR of at least 2.3, while medium-IOR materials as those with 1.8≤IOR<2.2.

In the first aspect of the invention, a thin layer with an index of refraction (IOR) of at least 2.3 at about 550 nm is used in combination with a medium-IOR aluminum nitride (AlN) layer in the subjacent portion of a silver-based solar-control stack deposited on a plastic substrate. Said high-index dielectric layer comprises niobium and oxygen. An example material is stoichiometric niobium pentoxide (Nb₂O₅). Other stoichiometries of niobium oxide, denoted as NbOₓ, or oxides of niobium alloyed with other metals, such as zirconium (Zr) or hafnium (Hf), may also be used. Zirconium nitride is an example of an alternative dielectric with an IOR=2.3 at 550 nm. The high-IOR layer may comprise one layer mentioned above or a combination of these layers.

NbOₓ, especially its stoichiometric form niobium pentoxide (Nb₂O₅), is more stable compared to TiOₓ, so it is less prone to phase transition and degradation. It is also more chemically stable under various conditions. The IOR of amorphous Nb₂O is 2.4 at 550 nm, which is higher than 2.25 of amorphous TiO₂. Nb₂O₅ is also known to be superior to TiO₂ dielectric as far as its transparency in the visible is concerned, primarily due to its wider bandgap of 3.4 eV compared to 3.2 eV for TiO₂. NbOₓ stays amorphous when deposited at room temperature. The comparative advantage of room-temperature deposited NbOₓ over TiOₓ is used in the present invention to provide a solar-control coating on a plastic substrate with superior optical transmission, clarity, stack simplicity, and chemical stability.

The use of AlN layers in the subjacent and superjacent portions of the disclosed stacks provides several advantages. AlN enables effective functionality as a wetting layer when deposited below the Ag functional layer as well as a blocker and optically active layer when deposited on top of it. Further improvements in the performance of solar-control coatings employing AlN can be achieved by adding trace amounts of hydrogen (as disclosed in a separate patent application filed by NxLite). Similar to traditional wetting layer comprising zinc aluminum oxide (ZnAlOₓ), AlN possesses <002> crystal orientation and promotes the growth of the desirable crystal orientation <111> of the silver functional layer. This ensures, among other characteristics, high optical transmittance in the visible and high reflectance in the IR spectral range, thus maximizing both optical and thermal performance of the coated glazing. AlN also provides adequate sodium blocking at room temperature.

Compared to closest prior art, i.e., U.S. Pat. No. 9,708,215B2, the present invention allows significant simplification in the optical design of the stack and enables the use of the combined optical thickness of high-IOR dielectrics outside the optical thickness range in the subjacent portion disclosed in U.S. Pat. No. 9,708,215B2. In an example embodiment, the percentage of the optical thickness of NbOₓ (high-IOR dielectric) to the total optical thickness of dielectrics in the subjacent portion of the present invention is at least 57%, which is greater than the upper limit value of 55% disclosed in U.S. Pat. No. 9,708,215B2.

The use of high-IOR NbOₓ and/or its high-IOR alternatives in the present invention also allows eliminating the need of using a high-IOR dielectric in the superjacent (above the silver layer) portion of the stack for achieving high Tvis. Fewer layers means fewer interfaces between dissimilar materials. This is particularly important for coatings on plastic substrates since plastic is prone to greater expansion and contraction compared to glass, which in turn is directly related to mechanical stresses placed on the coating.

In an embodiment, a solar-control stack comprises one functional layer comprising a pure silver and an Ag—Cu—Al alloy and a combination of dielectrics in its subjacent portion. Said combination of dielectrics comprises one high-IOR and one medium-IOR dielectrics, wherein the high-IOR dielectric is positioned between the substrate and one medium-IOR dielectric. The high-IOR dielectric is an oxide of Nb or one of its alloys or an oxide or nitride of Zr or one of its alloys. The medium-IOR layer comprises Al and N.

In an embodiment, a solar-control stack comprises one functional layer comprising a pure silver and an Ag—Cu—Al alloy and a combination of dielectrics in its subjacent portion. Said combination comprises two high-IOR dielectrics and two medium-IOR dielectrics. The sequence of the dielectrics, starting from the substrate is as follows: high-IOR layer, medium-IOR layer, high-IOR layer, medium-IOR layer. The high-IOR layer is an oxide of Nb or one of its alloys or an oxide or nitride of Zr or one of its alloys. The medium-IOR layer comprises Al and N.

In an embodiment, a solar-control stack comprises two functional layers, each comprising a pure silver and an Ag—Cu—Al alloy and a combination of dielectrics in its subjacent portion. Said combination of dielectrics comprises one high-IOR dielectric positioned between the substrate and one medium-IOR dielectric. The high-IOR layer is an oxide of Nb or one of its alloys or an oxide or nitride of Zr or one of its alloys. The medium-IOR layer comprises Al and N. Between the first NiCr blocker and the second functional layer, two additional dielectrics—high-IOR and medium-IOR are deposited. The high-IOR layer is an oxide of Nb or one of its alloys with Zr or Hf or an oxide or nitride of Zr or one of its alloys. The medium-IOR layer is AlN.

In an embodiment, an additional wetting layer comprising ZnAlOₓ is deposited between the AlN layer and the functional layer to further improve wetting properties of AlN.

In an embodiment, two silver functional layers are used to improve IR reflection of the stack. The functional layers are separated by an additional pair of a high-IOR and AlN dielectrics.

In some embodiments, the thickness of the plastic pane ranges from about 1.0 to about 16.0 mm, and preferably from about 0.5 to about 6.0 mm.

In some embodiments, the thickness of the solar-control coating is from about 100 to about 250 nm thick, preferably about 170 nm thick.

In some embodiments, the thickness of the high-IOR layers ranges from about 10 nm to about 20 nm. The thickness of the medium-IOR layers ranges from about 15 to about 50 nm. The thickness of the pure silver layer ranges from 0 to about 15 nm. The thickness of the alloyed silver layer ranges from 0 to about 15 nm. The thickness of the NiCr or NiCrOₓ layer ranges from 0 to about 3 nm. The thickness of the SiOₓN_{y} layer ranges from about 10 nm to about 30 nm.

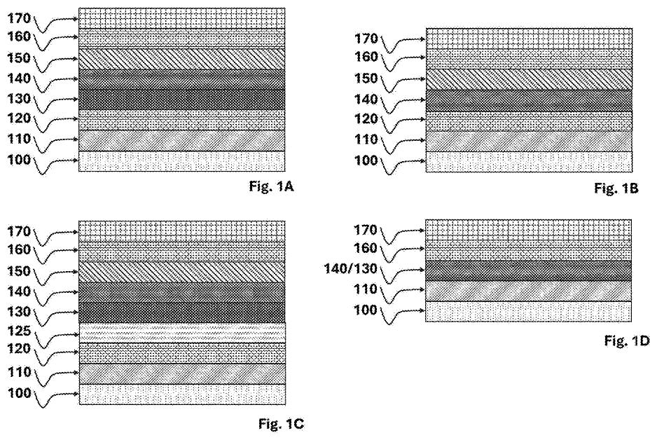

FIG. 1A depicts an example solar-control coating design according to the present invention. High-IOR dielectric 110, such as NbOₓ (or one of its alloys, or an oxide or nitride of Zr—ZrN or ZrO₂—or an oxide or nitride of one of its alloys), and a medium-index dielectric 120, such as AlN, form the first anti-reflection portion of the stack on a plastic substrate 100. AlN 120 also serves the role of a wetting layer to improve the crystallinity of the silver functional layer 130. The functional layer 130 may comprise pure silver, or a silver alloy with Cu and Al, or a combination thereof in the form of a, e.g., bilayer. The use of an alloyed Ag—Cu—Al layer 140 on top of the pure silver layer 130, for example, ensures corrosion resistant properties of the combined Ag/Ag—Cu—Al functional layer. Optional ultrathin NiCr or NiCrOₓ layer 150 is used as a blocker layer above the functional layer 130 and/or 140 to further enhance corrosion resistant properties of silver or silver alloy as well as to protect it from damage due to bombardment by energetic sputtering species during the deposition. The stack is terminated with a second AlN (medium-IOR dielectric) layer 160 and a SiOₓN_{y} layer 170, wherein SiOₓN_{y} 170, besides being an optically active material, also plays the role of a protective layer. ‘x’ in the SiOₓN_{y} formula may vary from 0 (Si₃N₄ ) to 1 (SiO₂). The ‘y’ will respectively range from 1 to 0.

Alloyed Ag—Cu—Al 140 may be used by itself as a functional layer, as depicted in an alternative stack design of FIG. 1B. In this case, the properties of the Ag—Cu—Al layer 140 are carefully balanced to provide a high Tvis and good corrosion resistance.

FIG. 1C shows another stack option with an additional wetting layer 125 inserted between the bottom AlN layer 120 and the silver functional layer 130 and/or 140. The purpose of this additional wetting layer is to improve the crystallinity and, thus, IR-reflecting properties of the silver functional layer 130 (optionally coupled with alloyed layer 140).

In the preferred embodiment of the present invention, the stack comprises a bilayer comprising pure silver and Ag—Cu—Al silver alloy. Other embodiments may include stacks comprising two or more silver functional layers separated from each other by a dielectric stack.

FIG. 1D shows another stack option wherein layers 120, 130, and 150 are absent. 140/130 means that one or the other layer is present but not both.

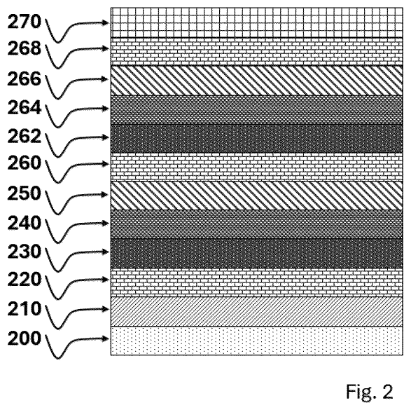

FIG. 2 shows a stack comprising two silver functional layers, each comprising a bilayer of pure silver (layers 230 and 262) and Ag—Cu—Al silver alloy (layers 240 and 264). In this case, additional NiCr blocker layer 266 and AlN layer 268 are added between the second functional layer 264 and the protective SiOₓN_{y} layer 270. Generally, the more silver layers are used in the coating, the better the ratio of optical transmission to the reflection of infrared light, albeit at the expense of an increased production cost and a lower Tvis. The typical number of silver layers in a sputtered solar-control coating is between one and three.

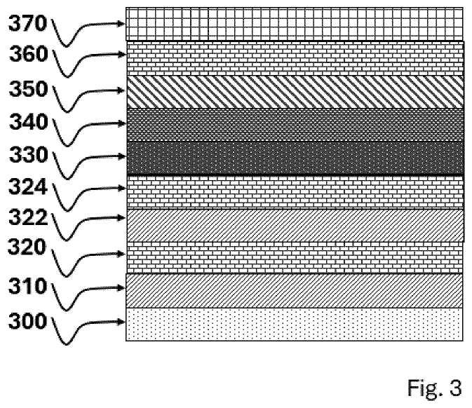

FIG. 3 shows a stack with one silver functional bilayer comprising a layer of pure silver 330 and a layer of alloyed silver 340. The subjacent portion comprises two pairs of high-IOR (layers 310 and 322) and medium-IOR dielectrics (layers 320 and 324). Just like layer 310, additional high-IOR layer 322 is an oxide of Nb or one of its alloys (with Zr or Hf) or an oxide or nitride of Zr or one of its alloys. Just like layer 320, additional medium-IOR layer 324 comprises AlN or one of its alloys and having an IOR in the range 1.8≤IOR<2.2. In this configuration, the first high-IOR layer is located between the substrate and the first medium-IOR layer. The second high-IOR layer is closer to the substrate than the second medium-IOR layer. Just like in the preferred design of FIG. 1A, there is no high-IOR layer in the superjacent portion of the stack, i.e., the portion between the last silver functional layer and the protective layer which terminates the stack.

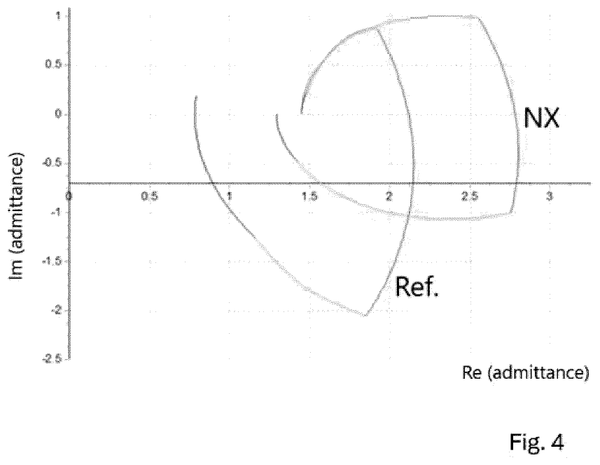

A remarkable attribute of the disclosed design of the present invention with a high-IOR NbOₓ in combination with medium-IOR AlN in the subjacent portion of the stack is a much wider locus of optical admittance (FIG. 4) as compared, for example, to that simulated from the design disclosed in U.S. Pat. No. 9,708,215B2.

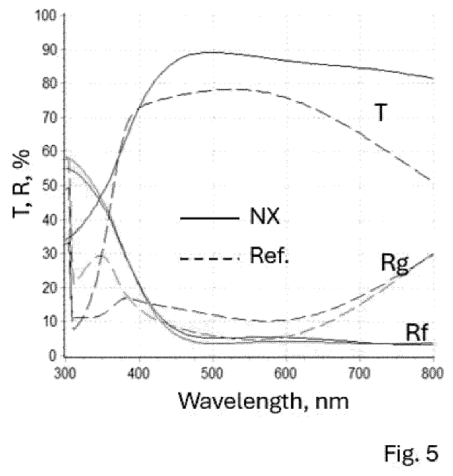

FIG. 5 shows a significantly improved visible transmittance of the stack according to the preferred embodiment of the present invention compared to the simulated reference stack disclosed in U.S. Pat. No. 9,708,215B2.

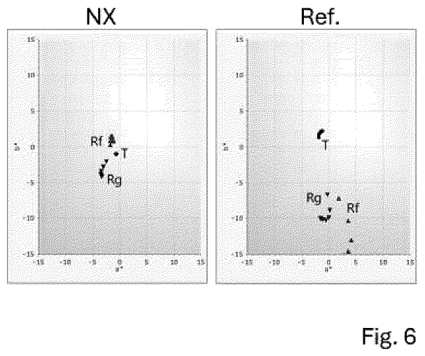

FIG. 6 shows a significantly improved (closer to neutral, i.e. a*=0 and b*=0) angular color distribution of transmitted and reflected light of the stack according to the preferred embodiment of the present invention compared to the simulated reference stack disclosed in U.S. Pat. No. 9,708,215B2.

Plastic panes of the present invention can be made of any polymer material, such as PMMA, PC, PET, etc.

Although sputtering is a preferred deposition technique, solar-control coating may alternatively be applied by any other means of deposition, such as another type of physical vacuum deposition (PVD) or chemical vapor deposition (CVD).

### Example 1

Example 1 is a solar-control stack with one functional bilayer sputter deposited on a 3 mm thick PMMA substrate. The functional bilayer comprises a 12 nm thick pure silver layer protected with a 12 nm alloyed Ag—Cu—Al layer and a 1.5 nm NiCr blocker layer. The subjacent portion of the stack comprises a 14 nm thick layer of stoichiometric Nb₂O₅ followed by a 35 nm thick layer of AlN. The superjacent portion comprises a 25 nm thick layer of AlN followed by a 20 nm thick layer of stoichiometric Si₃N₄.

### Example 2

Example 2 is similar to Example 1, except that an additional 7 nm thick wetting layer of ZnAlOₓ (with 2 wt % of Al) is introduced between the AlN and the functional layer in the subjacent portion of the stack.

### Example 3

Example 3 is similar to Example 1, except that an additional combination of Nb₂O₅ and AlN dielectrics is introduced in the subjacent portion of the stack. The total subjacent portion, starting from the substrate in this case is as follows: Nb₂O₅ (14 nm)/AlN (35)/Nb₂O₅ (12)/AlN (30).

### Example 4

Example 4 is similar to Example 1, except that an additional functional bilayer comprising pure Ag and Ag—Cu—Al alloy is added with same thicknesses of the pure-silver and alloyed silver layers as in Example 1. The two functional layers are separated by additional combination of Nb₂O₅ (14 nm) and AlN (30 nm).

### Example 5

Example 5 is similar to Example 1, except that it uses no pure Ag functional layer (only the Ag—Cu—Al functional layer), no medium-IOR layer in the subjacent part, and no NiCr or NiCrOₓ blocker layer above the functional layer.

### Advantages

The solar control structures disclosed herein are advantageous for several reasons. The combination of high-index-of-refraction (high-IOR), with IOR≥2.3 at 550 nm, and medium index-of-refraction (medium-IOR) with 1.8≤IOR<2.2 dielectrics in the subjacent (between the substrate and the silver functional layer) portion allows for a simplified stack with fewer layers while providing enhanced visible transmission and greater control over color properties. This means there is no need for a high-IOR material in the superjacent (above the silver functional layer) portion, as compared to currently known configurations.

A layer of substantially amorphous NbOₓ is superior to amorphous TiOₓ in terms of its higher IOR. Higher-IOR crystalline TiOₓ, especially rutile TiOₓ, adds absorption and coloration to the coating.

NbOₓ results in a broader optical admittance locus; this allows more flexible optical design possibilities which eliminate the need for additional complementary dielectrics.

Fewer dielectrics means fewer interfaces between dissimilar materials. In addition, fewer interfaces, in turn, means better mechanical stability which is especially important for coatings on plastic substrates which are prone to more expansion and contraction as compared to glass.

The present invention discloses two elements which work around the main limitations of—for example the Saint-Gobain patent U.S. Pat. No. 9,708,215 B2: a) the use of a high-IOR dielectric in the superjacent (above Ag) portion is no longer required and b) the percentage of the optical thickness of the total high-IOR portion to a total optical thickness of dielectrics in the subjacent portion in case of NbOₓ is at least 57%, as compared to the U.S. Pat. No. 9,708,215 B2 claimed range of 35-55%. The former limitation is more circumstantial and is open to interpretation. The latter is more direct.

1. A solar-control structure comprising:
an optically transparent alkali free substrate;
a first dielectric layer located on a surface of the substrate and having an index of refraction of at least 2.3 at a wavelength of about 550 nm and comprising a substantially amorphous oxide of Nb or one of its alloys with Zr or Hf or a substantially amorphous oxide or nitride of Zr, wherein the thickness of said first dielectric layer layer is from about 10 nm to about 20 nm;
a second dielectric layer located on first dielectric layer having an index of refraction smaller than about 2.2 but not smaller than about 1.8, wherein a thickness of said second dielectric layer ranges from 0 nm to about 50 nm;
a wetting layer located on second dielectric layer having a thickness from 0 to about 20 nm;
a first infrared reflecting functional layer located on wetting layer, wherein a thickness of said first infrared reflecting functional layer ranges from 0 to about 15 nm, the first infrared reflecting functional layer being made of pure Ag;
a second infrared reflecting functional layer located on first infrared reflecting functional layer having a thickness in a range from 0 to about 15 nm, the second infrared reflecting functional layer being silver alloyed with Cu and Al, wherein at least one of the first and second of the infrared reflecting functional layers is always present;
a layer of NiCr or NiCrOₓ (0≤x ≤0.6) on top of the infrared reflecting functional layer with a thickness ranging from 0 to about 4 nm;
an AlN-based layer on top of layer with thickness ranging from about 5 nm to about 50 nm;
a layer of SiOₓN_{y} (0≤x≤1; 1≥y≥0) on top of layer with thickness ranging from about 10 nm to about 30 nm; and
wherein there is no dielectric layer above the first and/or second infrared reflecting functional layers with an index of refraction equal to, or greater than about 2.1 at 550 nm.

2. The solar-control structure according to claim 1, wherein the oxide of Nb or one of its alloys with Zr or Hf of the first dielectric layer includes Nb₂O₅, (Nb, Zr)O₂, and (Nb, Hf)O₂.

3. The solar-control structure according to claim 1, wherein the nitride of Nb with Zr or Hf of the first dielectric layer includes NbZrN and NbHfN.

4. The solar-control structure according to claim 1, wherein the AlN-based layer is AlN.

5. The solar-control structure according to claim 1, wherein the AlN-based layer is any one of AlN:H, AlNₓO_{y}.

6. The solar-control structure according to claim 1, wherein only the first infrared reflecting functional layer is present.

7. The solar-control structure according to claim 1, wherein only the second infrared reflecting functional layer is present.

8. The solar-control structure according claim 1, wherein both the first and second infrared reflecting functional layers and are present.

9. The solar-control structure according to claim 1, wherein the second dielectric layer has a thickness of 0 nm so that it is absent.

10. The solar-control structure according to claim 1, wherein the second dielectric layer has a thickness of greater than 0 nm so that it is present.

11. The solar-control structure according to claim 1, wherein the layer (150) of NiCr or NiCrOₓ has a thickness of greater than 0 nm so that it is present.

12. The solar-control structure according to claim 1, wherein the layer of NiCr or NiCrOₓ has a thickness of 0 nm so that it is absent.

13. The solar-control structure according to claim 1, wherein the wetting layer has a thickness of 0 nm so that it is absent.

14. The solar-control structure according to claim 1, wherein the wetting layer has a thickness of greater than 0 nm so that it is present.

15. The solar-control structure according to claim 1, wherein the second dielectric layer is AlN.

16. The solar-control structure according to claim 1, further comprising a third dielectric layer located on top of dielectric layer having an index of refraction of at least 2.3 at a wavelength of about 550 nm and comprising an oxide of Nb or one of its alloys with Zr or Hf or an oxide or nitride of Zr, wherein the thickness of said layer is from about 10 nm to about 20 nm, and further comprising a fourth dielectric layer on top of second dielectric layer and below the infrared reflecting functional layer and having an index of refraction in a range from about 1.8 to about 2.2.

17. The solar-control structure according to claim 1, wherein the optically transparent alkali free substrate is a transparent polymeric or alkali free glass, and has a thickness from about 0.5 mm to about 16 mm.

18. (canceled)

19. A solar-control structure comprising:
an optically transparent alkali free substrate;
a first dielectric layer located on a surface of the substrate and having an index of refraction of at least 2.3 at a wavelength of about 550 nm and comprising a substantially amorphous oxide of Nb or one of its alloys with Zr or Hf or a substantially amorphous oxide or nitride of Zr, wherein the thickness of said first dielectric layer layer is from about 10 nm to about 20 nm;
a second dielectric layer located on first dielectric layer having an index of refraction smaller than about 2.2 but not smaller than about 1.8, wherein a thickness of said second dielectric layer ranges from 0 nm to about 50 nm;
a wetting layer located on second dielectric layer having a thickness from 0 to about 20 nm;
a first infrared reflecting functional layer located on wetting layer, wherein a thickness of said first infrared reflecting functional layer ranges from 0 to about 15 nm, the first infrared reflecting functional layer being made of pure Ag;
a second infrared reflecting functional layer located on first infrared reflecting functional layer having a thickness in a range from 0 to about 15 nm, the second infrared reflecting functional layer being silver alloyed with Cu and Al, wherein at least one of the first and second of the infrared reflecting functional layers is always present;
a layer of NiCr or NiCrOₓ (0≤x≤0.6) on top of the infrared reflecting functional layer with a thickness ranging from 0 to about 4 nm;
an AlN-based layer on top of layer with thickness ranging from about 5 nm to about 50 nm;
pure silver layer located on the AlN layer;
a Ag—Cu—Al silver alloy layer located on layer;
a NiCr layer located on layer;
an AlN layer located on layer;
a layer of SiOₓN_{y} (0≤x≤1; 1≥y≥0) on top of layer with thickness ranging from about 10 nm to about 30 nm; and
wherein there is no dielectric layer above the first and/or second infrared reflecting functional layers with an index of refraction equal to, or greater than about 2.1 at 550 nm.

20. The solar-control structure according to claim 19, wherein the optically transparent alkali free substrate is a transparent polymeric or alkali free glass, and has a thickness from about 0.5 mm to about 16 mm.

21. (canceled)
